(19) United States
(12) Patent Application Publication
(10) Pub. No.: US 2025/0029585 A1
(43) Pub. Date: Jan. 23, 2025

(54) AGGREGATE NOISE TREATMENT SYSTEMS AND METHODS

(71) Applicant: Shure Acquisition Holdings, Inc., Niles, IL (US)

(72) Inventors: Bijal Joshi, Elk Grove Village, IL (US); Matthew Robert Kirsch, Evanston, IL (US); Steven Christopher Moles, Lincolnshire, IL (US)

(21) Appl. No.: 18/774,320

(22) Filed: Jul. 16, 2024

Related U.S. Application Data
(60) Provisional application No. 63/517,793, filed on Aug. 4, 2023.
(60) Provisional application No. 63/514,052, filed on Jul. 17, 2023.

(51) Int. Cl. G10K 11/16

(52) U.S. Cl. CPC G10K 11/16

(57) ABSTRACT

Systems and methods are disclosed for providing a more consistent background noise for mixed audio transmitted from a local environment to a remote location. The systems and methods may generate and add aggregate comfort noise to a mixed audio signal, and the aggregate comfort noise may be based on noise spectral estimates from each audio device in an environment. Metrics related to speech and noise levels may be shared between the audio devices in an environment to modify the noise reduction processing of audio signals on each audio device.

### CROSS-REFERENCE

This application claims the benefit of U.S. Provisional Patent Application No. 63/517,793, filed on Aug. 4, 2023, and U.S. Provisional Patent Application No. 63/514,052, filed on Jul. 17, 2023, both of which are fully incorporated by reference in their entirety herein.

### TECHNICAL FIELD

This application generally relates to audio devices, and in particular, to systems and methods for providing a more consistent background noise for mixed audio transmitted from a local environment to a remote location.

### BACKGROUND

Conferencing environments, such as boardrooms, conferencing settings, and the like, can involve the use of microphones (including array microphones) for capturing sound from audio sources and loudspeakers for presenting audio from a remote location (also known as a far end). For example, persons in a conference room may be conducting a conference call with persons at a remote location. Typically, speech and sound from the conference room may be captured by microphones and transmitted to the remote location, while speech and sound from the remote location may be received and played on loudspeakers in the conference room. Multiple microphones may be used in order to optimally capture the speech and sound in the conference room. Each of the microphone and/or lobes of an array microphone may form a channel.

Typically, captured sound may also include noise (e.g., undesired non-voice or non-human sounds) in the environment, including constant noises such as from ventilation, machinery, and electronic devices, and errant noises such as sudden, impulsive, or recurrent sounds like shuffling of paper, opening of bags and containers, chewing, typing, etc. To minimize noise in captured sounds, an automixer can be utilized to automatically gate and/or attenuate a particular microphone or array microphone lobe's audio signal to mitigate the contribution of background, static, or stationary noise when it is not capturing human speech or voice. Voice activity detection (VAD) algorithms may also be used to minimize errant noises in captured sound by detecting the presence or absence of human speech or voice. Other noise reduction techniques can reduce certain background, static, or stationary noise, such as fan and HVAC system noise.

In addition, comfort noise may be generated and added to the audio signal sent from the conferencing environment to the remote location. Comfort noise is synthetic noise that is added to provide an audible confirmation to participants that a conferencing call or session is still connected, such as when no near end talkers are speaking. Comfort noise may also be used to mask audio artifacts caused by signal processing. In general, comfort noise may be shaped to match the frequency spectrum of the background noise in the local environment prior to any noise reduction processing.

Typical audio devices may generate comfort noise based on the sound captured on a particular device, and add or inject the generated comfort noise to the audio signals from the particular device before the audio signals are transmitted to an automixer. However, since the comfort noise is generated on each of the audio devices, there may be situations when the automixer is mixing audio signals that include injected comfort noises that have differing and inconsistent spectral shapes. For example, if one of the audio devices in an environment is closer to a noise source, the comfort noise added by that audio device may have a different spectral shape than the comfort noise added by another audio device that is farther from the noise source. Furthermore, audio devices of different types (handheld, lavalier, ceiling, tabletop, etc.), pickup patterns (cardioid, unidirectional, omnidirectional, etc.), technologies (MEMS, condenser, dynamic, etc.), etc. may capture sound differently and/or generate comfort noise in varying ways. Since the automixer may generate a mixed output signal that is based on the audio signals from such various audio devices, the background noise in the mixed output signal may undesirably fluctuate as the audio signals from the audio devices are gated on, for example.

### SUMMARY

The invention is intended to solve the above-noted problems by providing systems and methods that are designed to, among other things: (1) generate and add aggregate comfort noise to a mixed audio signal, where the aggregate comfort noise is based on noise spectral estimates from each audio device in an environment; and (2) share metrics related to speech and noise levels between the audio devices in an environment to modify the noise reduction processing of audio signals on each audio device.

In an embodiment, a system includes a plurality of microphone devices each configured to generate at least one audio signal based on detected sound, and to generate a noise spectral estimate based on the detected sound, and a comfort noise generator in communication with the plurality of microphone devices. The comfort noise generator may be configured to process the noise spectral estimate from each of the plurality of microphone devices and generate an aggregate comfort noise to be injected into a mixed output audio signal.

In another embodiment, a method includes generating, by each of a plurality of microphone devices, at least one audio signal based on detected sound; generating, by each of the plurality of microphone devices, a noise spectral estimate based on noise in the detected sound; and processing, by a comfort noise generator in communication with the plurality of microphone devices, the noise spectral estimate from each of the plurality of microphone devices to generate an aggregate comfort noise to be injected into a mixed output audio signal.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of a system including a plurality of array microphones, an automixer, and a comfort noise generator for generating an aggregate comfort noise for injection into a mixed audio signal, in accordance with some embodiments.

FIG. 2 is a schematic diagram of the comfort noise generator of the system of FIG. 1, in accordance with some embodiments.

FIG. 3 is a flowchart illustrating operations for generating the aggregate comfort noise using the system of FIG. 1, in accordance with some embodiments.

FIG. 4 is a schematic diagram of a system including a plurality of array microphones, an automixer, and a comfort noise generator for modifying the noise reduction processing on each array microphone, and for generating an aggregate comfort noise for injection into a mixed audio signal, in accordance with some embodiments.

FIG. 5 is a flowchart illustrating operations for modifying the noise reduction processing of an array microphone using the system of FIG. 4, in accordance with some embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The systems and methods described herein can provide a more consistent background noise for mixed audio signals that are sent from a local environment to a remote location, such as during a conferencing session. A comfort noise generator can be utilized to generate an aggregate comfort noise for the environment, based on noise spectral estimates produced by each audio device, e.g., microphone or array microphone, that are located in the environment. The comfort noise generator may generate an aggregate noise spectral estimate for the environment that can be used to generate the aggregate comfort noise. The aggregate comfort noise may be added or injected to an initial mixed output audio signal from an automixer to generate a final mixed output audio signal that can be transmitted to the remote location.

Aggregating the noise spectral estimates from each audio device in an environment can result in a final mixed output audio signal that minimizes background noise fluctuations, since the background noise from each audio device is taken into account when generating the aggregate comfort noise. In embodiments, each of the audio devices in an environment may share speech and noise-related information with one another so that the noise reduction processing on each audio device is modified and optimized. Accordingly, the system and methods described herein can improve the overall audio quality of conferencing sessions, resulting in increased satisfaction from the participants of the conferencing sessions.

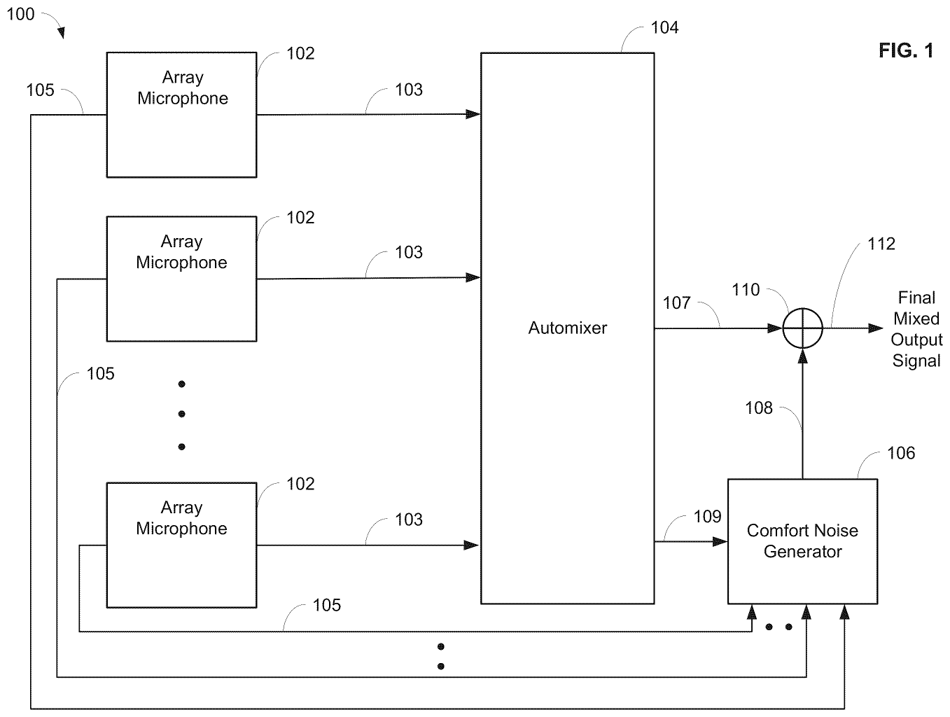

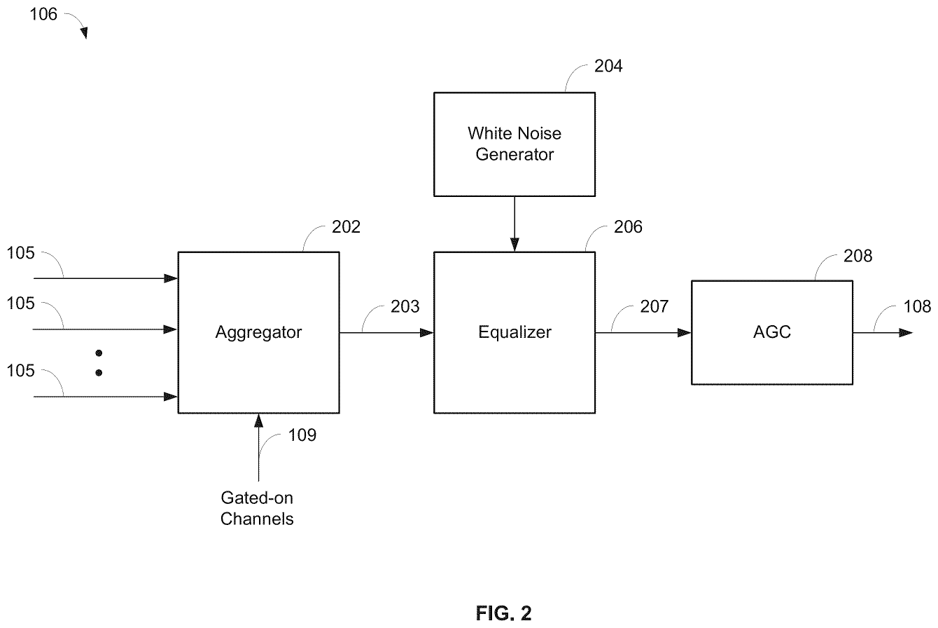

FIG. 1 is a schematic diagram of a system 100 including a plurality of array microphones 102, an automixer 104, and a comfort noise generator 106. FIG. 2 is a schematic diagram of components of the comfort noise generator 106 for generating an aggregate comfort noise 108 based on noise spectral estimates 105 from each of the plurality of array microphones 102.

In embodiments, the system 100 may be situated in an environment, such as a conference room, to facilitate communication with persons at a remote location and/or for sound reinforcement, for example. The environment may include desirable audio sources (e.g., human speakers) and/or undesirable audio sources (e.g., noise from ventilation, other persons, audio/visual equipment, electronic devices, etc.). The system 100 may result in the output of a final mixed output audio signal 112 that includes injected aggregate comfort noise 108 that takes into account the background noise sensed by each of the array microphones 102 and/or each lobe of each of the array microphones 102.

Each of the array microphones 102 may detect sound in the environment, and be placed on or in a table, lectern, desktop, wall, ceiling, etc. so that the sound from the audio sources can be detected and captured, such as speech spoken by human speakers. Each of the array microphones 102 may include any number of microphone elements, and be able to form multiple pickup patterns with lobes so that the sound from the audio sources can be detected and captured. Any appropriate number of microphone elements are possible and contemplated in each of the array microphones 102. Each array microphone 102 may convert the detected sound to an audio signal 103 that may be transmitted to the automixer 104. In embodiments, the audio signal 103 from an array microphone 102 may be a beamformed audio signal and/or may be a mixed audio signal. It should be understood that while array microphones 102 are shown in FIG. 1, other types of microphones are possible and contemplated to be used in the system 100.

Various components included in the system 100 may be implemented using software executable by one or more servers or computers, such as a computing device with a processor and memory, and/or by hardware (e.g., discrete logic circuits, application specific integrated circuits (ASIC), programmable gate arrays (PGA), field programmable gate arrays (FPGA), etc.). In general, a computer program product in accordance with the embodiments includes a computer usable storage medium (e.g., standard random access memory (RAM), an optical disc, a universal serial bus (USB) drive, or the like) having computer-readable program code embodied therein, wherein the computer-readable program code is adapted to be executed by a processor (e.g., working in connection with an operating system) to implement the methods described herein. In this regard, the program code may be implemented in any desired language, and may be implemented as machine code, assembly code, byte code, interpretable source code or the like (e.g., via C, C++, Java, ActionScript, Python, Objective-C, JavaScript, CSS, XML, and/or others).

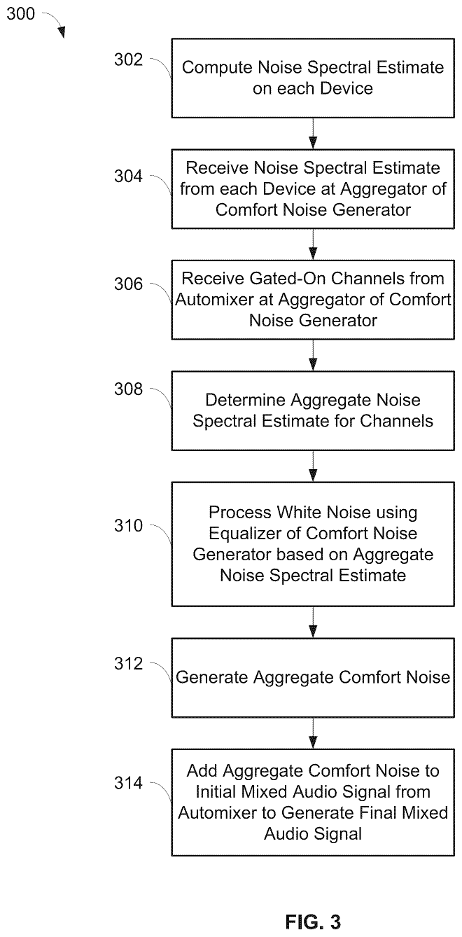

FIG. 3 illustrates a process 300 that utilizes the comfort noise generator 106 in the system 100 to generate an aggregate comfort noise 108 based on noise spectral estimates 105 received from each of the plurality of array microphones 102. One or more processors and/or other processing components (e.g., analog to digital converters, encryption chips, etc.) within or external to the system 100 may perform any, some, or all of the steps of the process 300. One or more other types of components (e.g., memory, input and/or output devices, transmitters, receivers, buffers, drivers, discrete components, etc.) may also be utilized in conjunction with the processors and/or other processing components to perform any, some, or all of the steps of the process 300.

At step 302, each array microphone 102 in the system 100 may compute a noise spectral estimate 105 that is based on the noise in the sound captured by the array microphone 102. The noise spectral estimate 105 may represent the spectral density of the noise in the sound captured by a particular array microphone 102 and characterize the frequency content of the noise. In some embodiments, the noise spectral estimate 105 computed by each array microphone 102 may be associated with the noise in each channel (e.g., beamformed signal or lobe) of the array microphone 102. In other embodiments, the noise spectral estimate 105 may be an overall estimate for the noise in all of the channels of the array microphone 102. In embodiments, the noise spectral estimate 105 computed by an array microphone 102 may include 64 frequency bands that are each 375 Hz wide, but other suitable numbers of frequency bands and widths are possible and contemplated.

In some embodiments, each array microphone 102 may perform noise reduction processing such that the noise in the sound captured by each array microphone 102 is substantially reduced and/or removed from each of the audio signals 103. The noise reduction processing may effectively prevent noise in the audio signals 103 from contributing to the initial mixed output audio signal 107 generated by the automixer 104, such that comfort noise of a desired spectrum and level, e.g., aggregate comfort noise 108, may be added to the initial mixed output audio signal 107 without interference. The noise spectral estimate 105 computed at step 302 in these embodiments may be based on the audio signals 103 prior to noise reduction processing, such that the aggregate noise spectral estimate 203 and the aggregate comfort noise 108 generated by the comfort noise generator 106 (e.g., at steps 308 and 312 described in more detail below) are also based on these pre-noise-reduced audio signals 103. The pre-noise-reduced audio signals 103 may be used to generate the noise spectral estimate 105 so that the resulting aggregate noise spectral estimate 203 more accurately represents the noise characteristics in the environment.

At step 304, the noise spectral estimate 105 may be received from each array microphone 102 at the aggregator 202 of the comfort noise generator 106, as shown in FIG. 2. In embodiments, the noise spectral estimate 105 may be transmitted as metadata by the array microphones 102 to the comfort noise generator 106 over any suitable wired or wireless audio transport channel, such as an audio over IP network transport solution. In other embodiments, the noise spectral estimate 105 may be transmitted as metadata by the array microphones 102 to the comfort noise generator 106 over a wired or wireless connection using any suitable communication protocol, such as Transmission Control Protocol/Internet Protocol (TCP/IP).

The automixer 104 may generate an initial mixed output audio signal 107 by mixing one or more of the audio signals 103 received from each of the array microphones 102. For example, the automixer 104 may gate on certain audio signals 103 so that they are not suppressed (or are minimally suppressed) and contribute to the initial mixed output audio signal 107. The audio signals 103 that are gated on may include desirable sound, such as human speech. The automixer 104 may also gate off other audio signals 103 so that they are attenuated or suppressed such that they do not significantly contribute to the initial mixed output audio signal 107. The audio signals 103 that are gated off may include undesirable sound, such as noise. An indication 109 of the audio signals 103 that are gated on by the automixer 104 may be received at step 306 by the aggregator 202 of the comfort noise generator 106.

At step 308, the aggregator 202 may determine an aggregate noise spectral estimate 203 based on the noise spectral estimates 105 corresponding to the audio signals 103 of the array microphones 102. In some embodiments, the aggregator 202 may utilize the noise spectral estimates 105 corresponding to the gated-on audio signals 103 to determine the aggregate noise spectral estimate 203, where the indication 109 of the gated-on audio signals 103 may be received at step 306. In other embodiments, the aggregator 202 may utilize the noise spectral estimates 105 corresponding to the audio signals 103 to determine the aggregate noise spectral estimate 203, without regard to whether the audio signals 103 have been gated on or not. In these embodiments, the indication 109 may not be received at step 306 and/or the indication 109 may be ignored at step 308.

The aggregate noise spectral estimate 203 may represent the spectral density of the overall noise in the environment, e.g., the conference room, where the array microphones 102 are located. The aggregator 202 may combine the noise spectral estimates 105 from the array microphones 102 to generate the aggregate noise spectral estimate 203 at step 308. In an embodiment, the aggregate noise spectral estimate 203 may be generated by the aggregator 202 by weighting the noise spectral estimate 105 with the lowest noise level differently than the other noise spectral estimates 105, then averaging the weighted and unweighted noise spectral estimates 105. In another embodiment, the aggregate noise spectral estimate 203 may be generated by the aggregator 202 by averaging the noise spectral estimates 105. In a further embodiment, the aggregate noise spectral estimate 203 may be generated by the aggregator 202 by taking a median of the noise spectral estimates 105.

At step 310, white noise produced by a white noise generator 204 in the comfort noise generator 106 may be processed by an equalizer 206 based on the aggregate noise spectral estimate 203. In particular, the equalizer 206 may shape the white noise to generate initial comfort noise 207 by adjusting the relative levels of the different frequencies of the white noise to match the shape of the aggregate noise spectral estimate 203. In embodiments, the number of bands of the equalizer 206 may be different, e.g., fewer, than the number of bands in the aggregate noise spectral estimate 203. For example, the equalizer 206 may have five bands and the aggregate noise spectral estimate 203 may have 64 bands.

In embodiments, the equalizer 206 may have various options or presets that can affect the processing performed by the equalizer 206. For example, there may be an option to utilize dynamically determined parameters to shape the white noise when generating the initial comfort noise 207, such as based on the levels of frequency subbands of the aggregate noise spectral estimate 203.

The aggregate comfort noise 108 may be generated at step 312 by an automatic gain control unit 208 in the comfort noise generator 106, based on the initial comfort noise 207 generated at step 310. The automatic gain control unit 208 may adjust the level of the initial comfort noise 207 to be more balanced and consistent before generating and outputting the aggregate comfort noise 108.

The automatic gain control unit 208 may have various settings to adjust the level of the initial comfort noise 207 when generating the aggregate comfort noise 108. For example, the settings may include a specific amount below the level of the initial comfort noise 207 (e.g., low, medium, or high settings). As other examples, the settings may include maintaining a constant specific level, or maintaining a level that changes based on the level of the noise in the aggregate noise spectral estimate 203.

At step 314, the final mixed output audio signal 112 may be generated at a summing point 110 by adding or injecting the aggregate comfort noise 108 generated by the comfort noise generator 106 to the initial mixed output audio signal 107 from the automixer 104. Accordingly, the audio in the final mixed output audio signal 112 may include the aggregate comfort noise 108 so that the background noise in the audio is more consistent and has minimal fluctuations, which can prevent audible noise floor changes from being heard by participants of a conferencing session. This is particularly important, for example, during periods when there are multiple near end alternately speaking talkers with different localized noise sources, when there are no near end talkers speaking, when the audio signals 103 from different array microphones 102 are gated on and off, and/or when the array microphones 102 are of varying types and technologies, have different pickup patterns, etc.

While multiple array microphones 102 in communication with an automixer 104 and a comfort noise generator 106 are depicted and described above with respect to the system 100 of FIG. 1 and the process 300 of FIG. 3, it is contemplated and possible that the automixer 104 and the comfort noise generator 106 may be included in a single audio device, e.g., an array microphone. Accordingly, in such an embodiment, a noise spectral estimate 105 may be generated for each lobe of the audio device, an aggregate noise spectral estimate 203 may be generated based on the noise spectral estimates 105 of each lobe, and an aggregate comfort noise 108 may be generated based on the aggregate noise spectral estimate 203. A final mixed output audio signal 112 may be generated by adding the aggregate comfort noise 108 to an initial mixed output audio signal 107. In this way, background noise fluctuations in the final mixed output audio signal 112 are minimized since the background noise from each lobe of the audio device may be taken into account when generating the aggregate comfort noise 108.

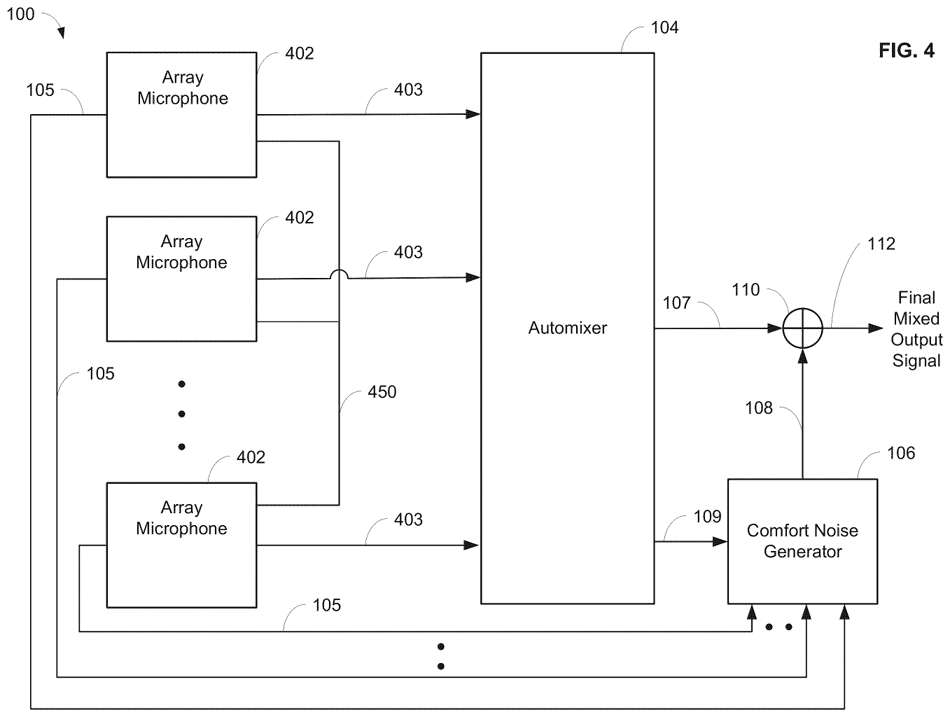

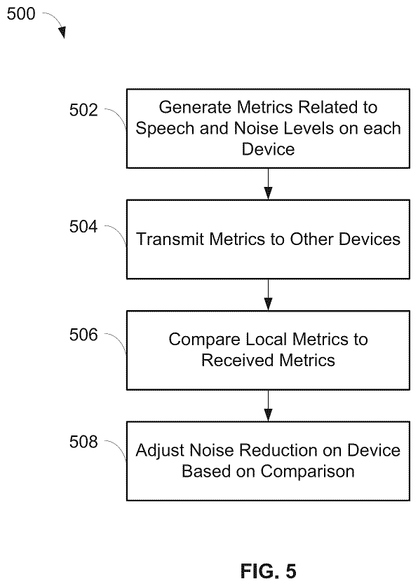

FIG. 4 is a schematic diagram of a system 400 including a plurality of array microphones 402, an automixer 104, and a comfort noise generator 106. The system 400 may enable the noise reduction processing of the array microphones 402 to be modified and improved based on information shared between the array microphones 402, as described by the process 500 shown in FIG. 5. This information may include metrics 450 related to the levels of speech and noise in the sound detected by an array microphone 402. Each array microphone 402 may convert the detected sound to a noise-reduced audio signal 403. For simplicity, the functionality of the automixer 104 and comfort noise generator 106 are as described previously and are not repeated.

One or more processors and/or other processing components (e.g., analog to digital converters, encryption chips, etc.) within or external to the microphone may perform any, some, or all of the steps of the process 500. One or more other types of components (e.g., memory, input and/or output devices, transmitters, receivers, buffers, drivers, discrete components, etc.) may also be utilized in conjunction with the processors and/or other processing components to perform any, some, or all of the steps of the process 500.

At step 502, each array microphone 402 in the system 400 may generate metrics 450 that are based on the sound detected captured by the array microphone 102, as shown in FIG. 4. In an embodiment, the metrics 450 generated by each array microphone 402 may include the levels of speech and noise in the sound captured by the array microphone 402 at different frequency subbands. In other embodiments, the metrics 450 may include different averaged levels (e.g., in each subband) that are computed using different time constants to obtain short-term or longer-term averages. The metrics 450 generated at step 502 may also be combined to form a speech-to-noise ratio in each subband that may be at different time scales, in embodiments.

The metrics 450 may be transmitted as metadata from each array microphone 402 to some or all of the other array microphones 402, at step 504. In embodiments, the metrics 450 may be transmitted from each array microphone 402 to an aggregator device (not shown). The transmission of the metrics 450 may be over any suitable wired or wireless audio transport channel, such as an audio over IP network transport solution. In other embodiments, the metrics 450 may be transmitted as metadata by an array microphone 102 to the other array microphones 102 over a wired or wireless connection using any suitable communication protocol, such as Transmission Control Protocol/Internet Protocol (TCP/IP).

At step 506, an array microphone 402 may compare its locally-generated metrics to the metrics 450 received from the other array microphones 402. In embodiments, an aggregator device that receives the metrics 450 from the array microphones 402 may perform the comparisons at step 506. The comparison may include averaging the metrics 450, and/or comparing short-term and long-term averages of the levels in the metrics 450.

Based on the comparison of the metrics 450 at step 506, the noise reduction processing on an array microphone 402 may be modified such that the noise included in the audio signal 403 is more consistent. For example, the amount of noise reduction in each frequency subband may be modified to achieve a desired output noise spectrum having a particular shape and/or level. In embodiments, the noise spectral estimate 105 computed by the array microphone 402 (e.g., at step 302 of the process 300 described above) may be based on the noise-reduced audio signals 403 generated by the process 500, such that the aggregate noise spectral estimate 203 and the aggregate comfort noise 108 generated by the comfort noise generator 106 are also based on the noise-reduced audio signals 403. In other embodiments, the process 500 may be utilized by the array microphones 402 in a system that does not have the comfort noise generator 106, such that the array microphones 402 locally generate and add comfort noise to each of the noise-reduced audio signals 403.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A system, comprising:
a plurality of microphone devices each configured to generate at least one audio signal based on detected sound, and to generate a noise spectral estimate based on noise in the detected sound; and
a comfort noise generator in communication with the plurality of microphone devices, the comfort noise generator configured to process the noise spectral estimate from each of the plurality of microphone devices and generate an aggregate comfort noise to be injected into a mixed output audio signal.

2. The system of claim 1, further comprising:
an automixer in communication with each of the plurality of microphone devices, the automixer configured to process the at least one audio signal from each of the plurality of microphone devices and generate the mixed output audio signal; and
a summing point configured to generate a final mixed output audio signal based on the mixed output audio signal and the aggregate comfort noise.

3. The system of claim 2, wherein each of the plurality of microphone devices is further configured to perform noise reduction on the at least one audio signal to generate at least one noise-reduced audio signal, and wherein the automixer is configured to process the at least one noise-reduced audio signal and generate the mixed output audio signal.

4. The system of claim 1, wherein the comfort noise generator comprises:
an aggregator configured to receive and process the noise spectral estimate from each of the plurality of microphone devices to generate an aggregate noise spectral estimate; and
an equalizer configured to generate the aggregate comfort noise based on the aggregate noise spectral estimate.

5. The system of claim 4, wherein the comfort noise generator is further in communication with an automixer, and wherein the aggregator is further configured to generate the aggregate noise spectral estimate based on the noise spectral estimate from the plurality of microphone devices that are gated-on by the automixer.

6. The system of claim 4, wherein the comfort noise generator further comprises a white noise generator configured to generate white noise, and wherein the equalizer is further configured to process the white noise based on the aggregate noise spectral estimate to generate the aggregate comfort noise.

7. The system of claim 1, wherein the noise spectral estimate from each of the plurality of microphone devices comprises one or more noise spectral estimates associated with each channel of the microphone device.

8. The system of claim 1, wherein each of the plurality of microphone devices is further configured to:
generate metrics related to levels of speech and noise in the at least one audio signal; and
transmit the metrics to one or more of an aggregator device or the other microphone devices of the plurality of microphone devices.

9. The system of claim 8, wherein each of the plurality of microphone devices is further configured to adjust noise reduction of the at least one audio signal based on the metrics received from the other microphone devices of the plurality of microphone devices.

10. The system of claim 1, wherein the comfort noise generator comprises:
an aggregator configured to receive and process the noise spectral estimate from each of the plurality of microphone devices to generate an aggregate noise spectral estimate;
an equalizer configured to generate an initial comfort noise based on the aggregate noise spectral estimate; and
an automatic gain control unit configured to generate the aggregate comfort noise based on the initial comfort noise.

11. A method, comprising:
generating, by each of a plurality of microphone devices, at least one audio signal based on detected sound;
generating, by each of the plurality of microphone devices, a noise spectral estimate based on noise in the detected sound; and
processing, by a comfort noise generator in communication with the plurality of microphone devices, the noise spectral estimate from each of the plurality of microphone devices to generate an aggregate comfort noise to be injected into a mixed output audio signal.

12. The method of claim 11, further comprising:
processing, by an automixer in communication with each of the plurality of microphone devices, the at least one audio signal from each of the plurality of microphone devices to generate the mixed output audio signal; and
generating, by a summing point, a final mixed output audio signal based on the mixed output audio signal and the aggregate comfort noise.

13. The method of claim 12, further comprising:
performing, by each of the plurality of microphone devices, noise reduction on the at least one audio signal to generate at least one noise-reduced audio signal; and
processing, by the automixer, the at least one noise-reduced audio signal to generate the mixed output audio signal.

14. The method of claim 11, further comprising:
receiving and processing, by an aggregator of the comfort noise generator, the noise spectral estimate from each of the plurality of microphone devices to generate an aggregate noise spectral estimate; and
generating, by an equalizer of the comfort noise generator, the aggregate comfort noise based on the aggregate noise spectral estimate.

15. The method of claim 14, further comprising generating, by the aggregator, the aggregate noise spectral estimate based on the noise spectral estimate from the plurality of microphone devices that are gated-on by an automixer.

16. The method of claim 14, further comprising generating, by a white noise generator of the comfort noise generator, white noise, and wherein generating the aggregate comfort noise comprises processing, by the equalizer, the white noise based on the aggregate noise spectral estimate to generate the aggregate comfort noise.

17. The method of claim 11, wherein the noise spectral estimate from each of the plurality of microphone devices comprises one or more noise spectral estimates associated with each channel of the microphone device.

18. The method of claim 11, further comprising, by each of the plurality of microphone devices:
generating metrics related to levels of speech and noise in the at least one audio signal; and
transmitting the metrics to one or more of an aggregator device or the other microphone devices of the plurality of microphone devices.

19. The method of claim 18, further comprising adjusting, by each of the plurality of microphone devices, noise reduction of the at least one audio signal based on the metrics received from the other microphone devices of the plurality of microphone devices.

20. The method of claim 11, further comprising:
receiving and processing, by an aggregator of the comfort noise generator, the noise spectral estimate from each of the plurality of microphone devices to generate an aggregate noise spectral estimate;
generating, by an equalizer of the comfort noise generator, an initial comfort noise based on the aggregate noise spectral estimate; and
generating, by an automatic gain control unit of the comfort noise generator, the aggregate comfort noise based on the initial comfort noise.
